(19) United States
(12) Patent Application Publication
(10) Pub. No.: US 2015/0043209 A1
(43) Pub. Date: Feb. 12, 2015

(54) Illuminated Spacer For Fishing Rod Holders, Cup Holders, And The Like

(71) Applicant: David B. Nirenberg, Bonita Springs, FL (US)

(72) Inventor: David B. Nirenberg, Bonita Springs, FL (US)

(21) Appl. No.: 13/963,366

(22) Filed: Aug. 9, 2013

(51) Int. Cl. F21K 99/00

(52) U.S. Cl. CPC F21K 9/00
USPC 362/249.06; 362/249.01

(57) ABSTRACT

An illuminated spacer for supporting and illuminating an article holder such as a fishing rod holder or a cup holder includes a base having substantially planar upper and lower surfaces, a peripheral outer surface connecting the upper and lower surfaces, and an inner surface connecting the upper and lower surfaces and forming a central opening extending between the upper and lower surfaces. The base also has a circumferentially extending groove encircling the central opening and located between the inner and outer surfaces. A waterproof and flexible light strip having a plurality of space-apart LED lights is located within the groove and extends substantially around the entire central opening. At least a portion of the base is light transmissive so that light produced by the LED lights is transmitted through the outer peripheral surface so that the article holder can be easily seen at night.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to accessories for boats and the like, and more specifically, to article holders such as fishing rod holders, cup holders, and the like.

### BACKGROUND OF THE INVENTION

Boat lighting systems typically include navigational lights, functional lights, and accent lights. While each of these existing boat lighting systems may adequately serve their intended purpose, they often do not provide adequate illumination for accessories used after dusk or at night. During night fishing it can often be difficult to locate fishing poles in a timely manner. Also, during night boating it can be difficult to locate a drink left in a cup holder. After market modifications to boat lighting systems are available but they can be expensive to purchase and install and may not even be very effective. Accordingly, there is a need for improved illumination device for boat accessories such as fishing rod holders, cup holders, and the like.

### SUMMARY OF THE INVENTION

Disclosed herein are illuminated article holder assemblies which overcome at least one of the deficiencies of the prior art. Disclosed is an illuminated spacer comprising, in combination, a base having a substantially planar upper surface, a substantially planar lower surface opposite the upper surface, a peripheral outer surface connecting the upper and lower surfaces, and an inner surface connecting the upper and lower surfaces and forming a central opening extending from the upper surface to the lower surface. The base has a circumferentially extending groove encircling the central opening and located between the inner surface and the outer surface. A plurality of spaced-apart electric lights is located within the groove. At least a portion of the base is light transmissive so that at least a portion of light produced by the electric lights is transmitted through the outer surface.

Also disclosed is an article holder assembly comprising, in combination, an article holder and an illuminated spacer. The article holder includes a cylindrically shaped body having a substantially closed lower end, an open upper end, and an upper flange radially extending outward about a circumference of the upper end of the body. The illuminated spacer includes a base having a substantially planar upper surface, a substantially planar lower surface opposite the upper surface, a peripheral outer surface connecting the upper and lower surfaces, and an inner surface connecting the upper and lower surfaces and forming a central opening extending from the upper surface to the lower surface. The base has a circumferentially extending groove encircling the central opening and located between the inner surface and the outer surface. The illuminated spacer further includes a plurality of spaced-apart electric lights located within the groove. At least a portion of the base is light transmissive so that at least a portion of light produced by the electric lights is transmitted through the outer surface. A lower surface of the upper flange of the article holder engages and is supported on the upper surface of the base and the body of the article holder extends through the central opening of the base.

Also disclosed is a boat comprising, in combination, a wall having an opening, and article holder assembly including an article holder and an illuminated spacer. The article holder includes a cylindrically shaped body having a substantially closed lower end, an open upper end, and an upper flange radially extending outward about the circumference of the upper end of the body. The illuminated spacer includes a base having a substantially planar upper surface, a substantially planar lower surface opposite the upper surface, a peripheral outer surface connecting the upper and lower surfaces, and an inner surface connecting the upper and lower surfaces and forming a central opening extending from the upper surface to the lower surface. The base has a circumferentially extending groove encircling the central opening and located between the inner surface and the outer surface. The illuminated spacer further includes a waterproof and flexible light strip having a plurality of flexible LED lights located within the groove and extending substantially around the entire central opening. At least a portion of the base is light transmissive so that at least a portion of light produced by the LED lights is transmitted through the outer peripheral surface. The lower surface of the base of the illuminated spacer engages and is supported on the wall with the central opening of the base of the illuminated spacer located at the opening in the wall, a lower surface of the upper flange of the article holder engages and is supported on the upper surface of base of the illuminated spacer, and the body of the article holder is extending through the central opening of the base of the illuminated spacer and the opening of the wall.

From the foregoing disclosure and the following more detailed description of various preferred embodiments it will be apparent to those skilled in the art that the present invention provides a significant advance in the technology and art of boat article holding assemblies. Particularly significant in this regard is the potential the invention affords for providing reliable and relatively low cost retrofit lighting devices. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a portion of a boat with an illuminated fishing rod holder assembly according to the present invention.

FIG. 2 is another perspective view of the illuminated fishing rod holder assembly of FIG. 1, wherein a cover is removed for clarity.

FIG. 3 is perspective view of the fishing rod holder of the illuminated fishing rod holder assembly of FIGS. 1 and 2.

FIG. 4 is a top perspective view of an illuminated spacer of the illuminated fishing rod holder assembly of FIGS. 1 and 2.

FIG. 5 is a bottom perspective view of the illuminated spacer of FIG. 4.

FIG. 6 is bottom view of the illuminated spacer of FIGS. 4 and 5.

FIG. 7 is top view of the illuminated spacer of FIGS. 4 to 6.

FIG. 8 is a sectional view taken along line 8-8 of FIG. 6.

FIG. 9 is an enlarged fragmented view taken along circle 9 of FIG. 8.

FIG. 10 is a sectional view taken along line 10-10 of FIG. 6.

FIG. 11 is a sectional view taken along line 11-11 of FIG. 6.

FIG. 12 is a sectional view of the illuminated fishing rod holder assembly of FIGS. 1 and 2.

FIG. 13 is a schematic view of an exemplary power circuit for the illuminated fishing rod holder assembly of FIGS. 1 and 2.

FIG. 14 is a perspective view of an illuminated cup holder assembly installed on a boat according to the present invention.

FIG. 15 is another perspective view of the illuminated cup holder assembly of FIG. 14.

FIG. 16 is perspective view of a cup holder of the illuminated cup holder assembly of FIGS. 14 and 15.

FIG. 17 is a top perspective view of an illuminated spacer of the illuminated cup holder assembly of FIGS. 14 and 15.

FIG. 18 is top view of the illuminated spacer of FIG. 17.

FIG. 19 is bottom view of the illuminated spacer of FIGS. 17 and 18.

FIG. 20 is side view of the illuminated spacer of FIGS. 17 to 19.

FIG. 21 is a sectional view taken along line 21-21 of FIG. 19.

FIG. 22 is an enlarged fragmented view taken along circle 22 of FIG. 21.

FIG. 23 is an enlarged fragmented view taken along circle 23 of FIG. 19.

FIG. 24 is a sectional view of the illuminated cup holder assembly of FIGS. 14 and 15.

It should be understood that the appended drawings are not necessarily to scale, presenting a somewhat simplified representation of various preferred features illustrative of the basic principles of the invention. The specific design features of the illuminated article holding assemblies as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the retrofit switching devices illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved illuminated article holding assemblies disclosed herein. The following detailed discussion of various alternative and preferred embodiments will illustrate the general principles of the invention. Other embodiments suitable for other applications will be apparent to those skilled in the art given the benefit of this disclosure.

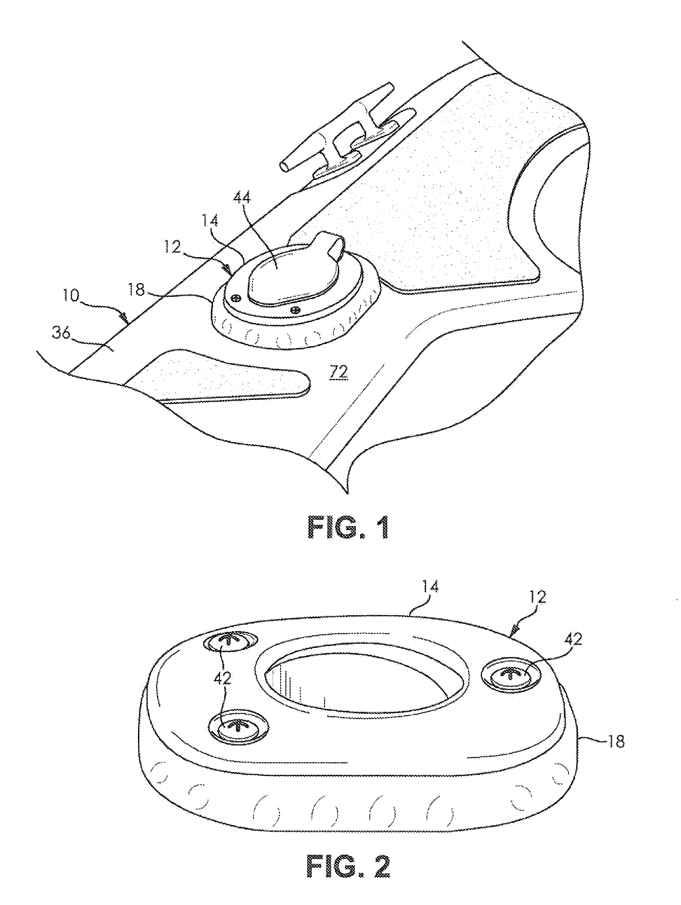

Referring now to the drawings, FIGS. 1, 2, and 12 illustrate a portion of a watercraft or boat 10 having an illuminated article holder assembly 12 according to a first embodiment of the present invention. The illustrated article holder assembly 12 includes an article holder 14 in the form of fishing rod holder configured for holding a fishing rod 16, and an illuminated spacer or bezel 18 having a base 46 located below and supporting the fishing rod holder 14 and a plurality of spaced-apart electric lights 22 located within the base and illuminating the fishing rod holder 14. The illustrated illuminated spacer or bezel 18 is a separate component from the fishing rod holder 14 so that the illuminated spacer 18 can be utilized to illuminate any suitable commercially available fishing rod holder 14 that is available either off-the shelf or as original equipment from a boat OEM. It is noted that the article holder 14 can alternatively be any other suitable type of article holder such as, for example, a cup holder and the like.

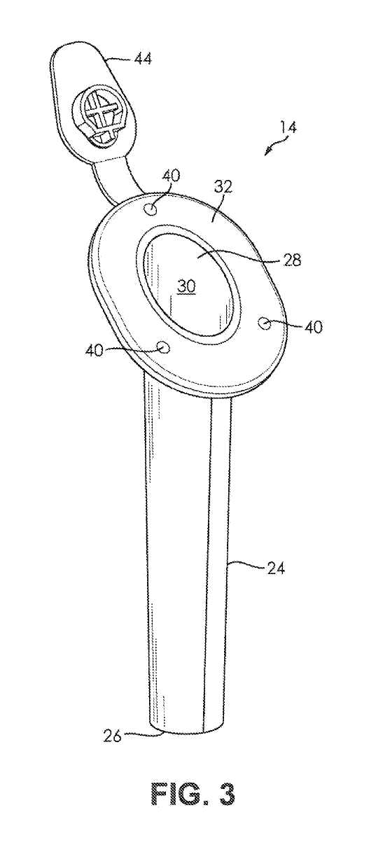

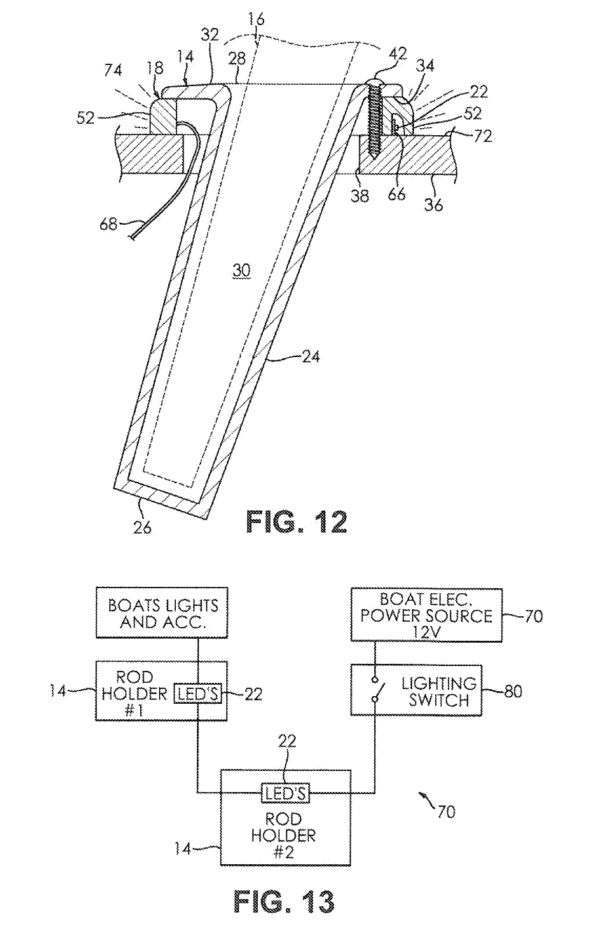

As best shown in FIG. 3, the illustrated fishing rod holder 14 is a flush-type fishing rod holder that includes a cylindrically shaped body 24 having a substantially closed lower end 26 and an open upper end 28 forming an interior cavity 30 and an upper flange 32 extending radially outward from the top of the body 24. The body 24 and its interior cavity 30 are sized for receiving and holding the lower end of the fishing rod 16. The illustrated upper flange 32 has a planer lower surface 34 for supporting the fishing rod holder 14 on the illuminated spacer 18 (but typically on the boat wall 36 when a spacer 18 is not present) with the body 24 extending through an opening 38 in the wall 36 (best shown in FIG. 12). The illustrated upper flange 32 has a circumference sized larger than a diameter of the wall opening 38 so that the flange 32 will not pass through the wall opening 38. The illustrated body 24 has diameter sized smaller than the diameter of the wall opening 38 so that the body 24 can be inserted through the wall opening 38. The illustrated body 24 extends from the upper flange 32 at an acute angle so that the fishing rod 16 is held at a non-vertical and non-horizontal position. The illustrated fishing rod holder 14 is formed of stainless steel but the fishing rod holder 14 can alternatively be formed of any other suitable material such as, for example, plastic, other metals, and other suitable materials.

The illustrated upper flange 32 is provided with a plurality of fastener openings 40 for receiving mechanical fasteners 42 such as the illustrated screws that extend through the upper flange 32 and into the boat wall 36 to secure the upper flange 32 to the boat wall 36 (best shown in FIG. 12). The illustrated upper flange 32 is provided with three fastener openings 40 but any other suitable number of fastener openings 40 can alternatively be utilized. It is noted, however, that the fishing rod holder 14 can alternatively be secured to the boat wall 36 in any other suitable manner or can alternatively be unsecured.

The illustrated fishing rod holder 14 is also provided with a tethered cap or plug 44 sized and shaped for selectively closing the open upper end 28 of the body 24 to prevent the entrance of water and other debris therein that could accumulate within the body 24. The cap or plug 44 can be of any suitable type and can be eliminated if desired. It is noted that the body 24 can alternatively or additionally be provided with a suitable drain opening or openings to prevent the accumulation of water and other debris within the body 24.

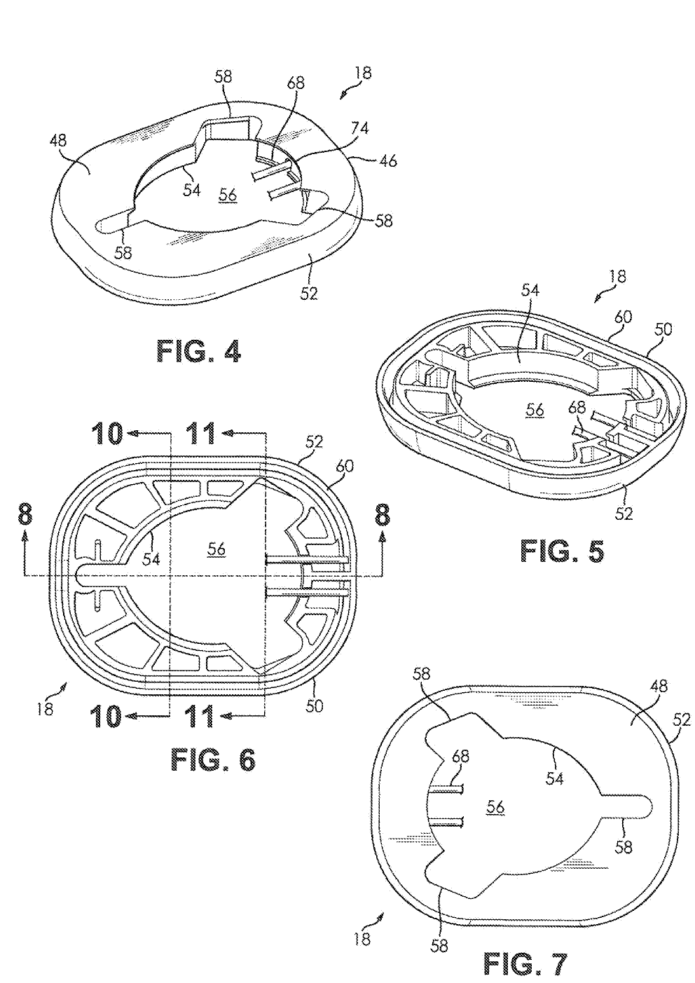

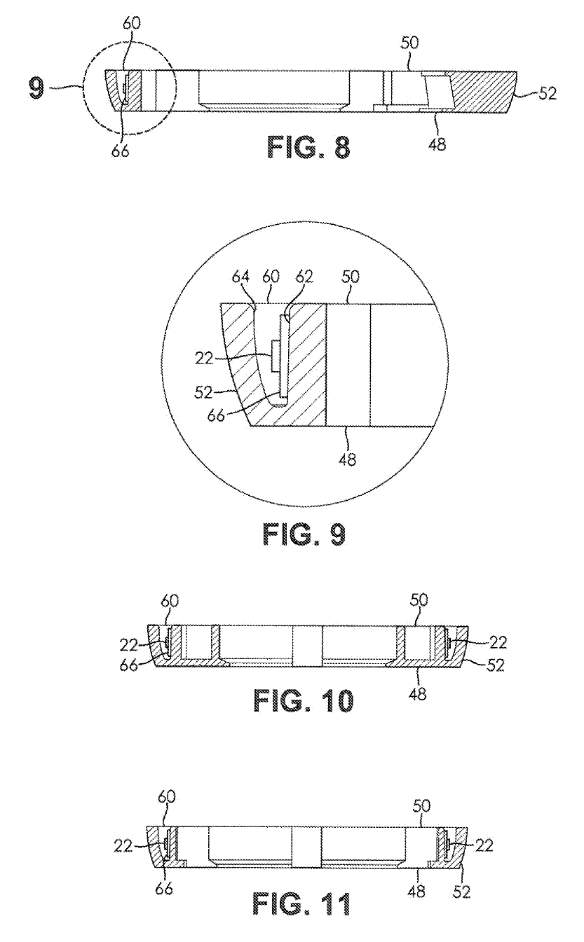

As best shown in FIGS. 4 to 12, the illustrated illuminated spacer or bezel 18 includes the base 46 and the plurality of spaced-apart electric lights 22. The illustrated spacer 18 is configured to be retained between the upper flange 32 of the fishing rod holder 14 and the boat wall 36. The illustrated base 46 is generally ring-shaped having a substantially planar or flat upper surface 48, a substantially planar or flat lower surface 50 opposite the upper surface 48, a peripheral outer surface 52 connecting the upper and lower surfaces 48, 50, and an inner surface 54 connecting the upper and lower surfaces 48, 50 and forming a central opening 56 extending from the upper surface or the lower surface 48, 50. The illustrated upper surface 48 is sized larger than the wall opening 38 and substantially the same or slightly larger than the upper flange 32 of the fishing rod holder 14 so that the lower surface 34 of the body upper flange 32 can engage and be supported on the upper surface 48 of the spacer 18. The illustrated lower surface 50 is also sized larger than the wall opening 38 so that the lower surface 50 can engage and be supported on the boat wall 36 about the wall opening 38. The illustrated peripheral outer surface 52 is generally oval shaped and extends the full periphery of the base 46. The illustrated outer surface 52 is sized to extend the full height of the gap between the boat wall 36 and the upper flange 32 of the fishing rod holder 14. The illustrated outer surface 52 is arcuate or convex in vertical planes between the upper and low surfaces 48, 50 so that light from the plurality of spaced-apart electric lights 22 is directed in a nonlinear manner (that is, distributed in more than one direction within the vertical planes). It is noted, however, that the outer surface 52 can alternatively have any other suitable shape. The illustrated inner surface 54 is sized to extend the full height of the gap between the boat wall 36 and the upper flange 32 of the fishing rod holder 14 and is substantially vertical. It is noted, however, that the inner surface 54 can alternatively have any other suitable shape. The central opening 56 formed by the inner surface 54 is sized and shaped for passage of the body 24 of the fishing rod holder 14 therethrough with clearance (best shown in FIG. 12).

The illustrated base 46 is provided with a plurality of circumferentially spaced-apart fastener clearance openings 58 which align with the fastener openings 40 of the fishing rod holder 14 for passage of the mechanical fasteners 42 therethrough from the fishing rod holder 14 to the boat wall 36. The illustrated clearance openings 58 are in the form of notches that open into the central opening 56 so that the base 46 can be used with a wide variety of fishing rod holders 14 but the clearance openings 58 can alternatively can have any other suitable size and/or shape.

A downward facing groove or track 60 extends about substantially the entire circumference of the base 46 and encircling the central opening 56. The illustrated groove 60 is located between the outer and inner surfaces 52, 54 and is located near the outer peripheral surface 52. The groove 60 is sized for receiving and holding the plurality of spaced-apart electric lights 22 therein to illuminate the outer peripheral outer surface 52 (best shown in FIG. 12). The illustrated groove 60 has a substantially vertical inner surface 62 and an arcuate or concave outer surface 64 that corresponds to the shape of the peripheral outer surface 52 of the base 46. The illustrated groove 60 is open at the lower surface 50 for insertion of the electric lights 22 and access to the electric lights 22. It is noted, however, that the groove 60 can alternatively have any other suitable configuration.

The illustrated base 46 is advantageously molded of a suitable plastic in a one-piece construction but can alternatively be formed in other manners and/or formed of multiple components secured together. At least a portion of the illuminated base 46 is formed of a material suitable for transmitting visible light from the electric lights 22 to at least the outer peripheral surface 52. The material is preferably translucent but can be transparent or otherwise visible light transmissive. The illustrated illuminated base 46 is molded of a single translucent plastic material but any other suitable material or combination of materials can alternatively be utilized.

The plurality of spaced-apart electric lights 22 are provided in the groove 60 of the base 46 to illuminate at least the outer peripheral surface 52 of the base 46. The illustrated electric lights 22 are provided in the form of a flexible strip of LED lights 66 having a plurality of spaced-apart LED lights 22. The illustrated strip of LED lights 66 is water proof in that the strip of LED lights 66 is surrounded or encased by a polymeric or plastic material such as, for example, silicone or the like. Thus, the strip of LED lights 66 is sealed against the entry of moisture and only the electric wires 68 extend therethrough. It is noted that the electric lights 22 can alternatively be any other suitable type of LED lights or any other suitable type of electric lights. The electric wires 68 extend from the strip of LED lights 66 for connection to the boat illumination or lighting system 70. The electric wires 68 can be provided with electrical connectors for easy connection to the boat lighting system 70.

The illustrated strip of LED lights 66 is positioned in the groove 60 against the inner surface 62 of the groove 60 with the LED lights 22 facing outward toward the outer surface 64 of the groove 60 and the peripheral outer surface 52 of the base 46. The illustrated strip of LED lights 66 has a length that extends substantially the entire distance of the groove 60 so that it encircles the central opening 56 of the base 46. The strip of LED lights 66 can be secured to the base 46 within the groove 60 in any suitable manner such as, for example, adhesive, adhesive, tape, and the like.

As best shown in FIG. 12, the illuminated base is positioned between the boat wall 36 and the upper flange 52 of the fishing rod holder 14 such that the lower surface 50 of the illuminated base 46 directly rests on the upper surface 72 of the boat wall 36 and the lower surface 34 of the upper flange 32 rests directly on the upper surface 48 of the illuminated base 46. The body 24 of the fishing rod holder 14 extends downwardly from the flange 32 through the central opening 56 in the illuminated base 46 and through the opening 38 in the boat wall 36. The plurality of electric lights 22 is located in the groove 60 of the illuminated base 46 and the electric wires 68 extend from the groove 60 to the central opening 56 through a wire passage 74 extending between the groove 60 and the central opening 56. The electric wires 68 then extend down through the opening 38 in the boat wall 36 to the boat illumination or lighting system 70. When power is selectively supplied to the plurality of electric lights 22, the electric lights 22 illuminate the outer peripheral surface 52 of the base 46. Thus, the circumference of the upper open end 28 of the fishing rod holder 14 is surrounded by illumination and can be easily seen at night.

As best shown in FIG. 13, one or more of the strips of LED lights 66 can be connected to the boat lighting system 70 so that they are powered by the boat electric power source 78 (preferably a 12 V DC battery). Alternatively, they could be provided with their own battery. The illustrated boat lighting system 70 has a single switch 80 but it is noted that more than one switch 80 can be alternatively be provided. For example, the strips of LED lights 66 can together have a dedicated switch separate from other boat lights or each of the strips of LED lights 66 can have its own dedicated switch.

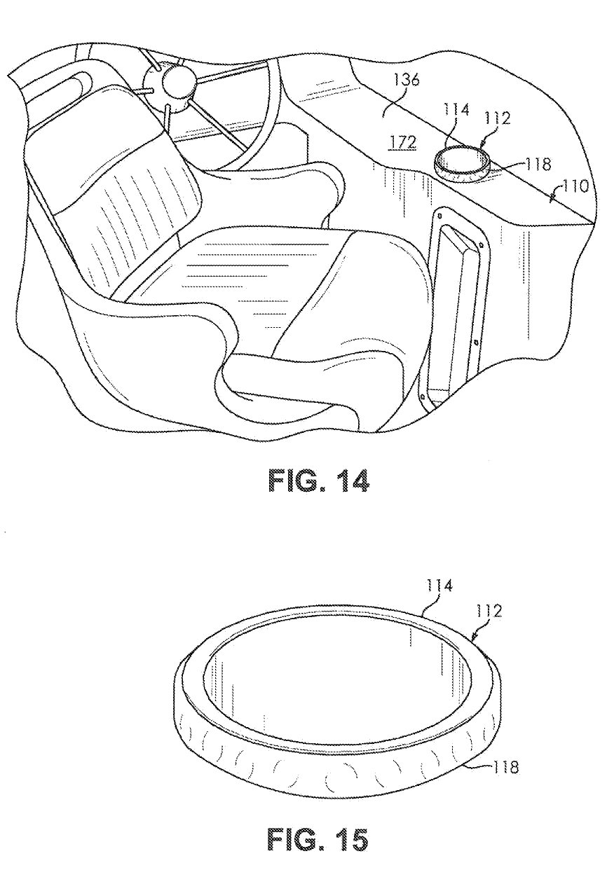

FIGS. 14, 15 and 24 illustrate a portion of a watercraft or boat 10 having an illuminated article holder assembly 112 according a second embodiment of the present invention. The illustrated article holder assembly 112 includes an article holder 114 in the form of cup holder configured for holding a cup or bottle 116, and an illuminated spacer or bezel 118 having a base 146 located below and supporting the cup holder and a plurality of spaced-apart electric lights 122 located within the base 146 and illuminating the cup holder 116. The illustrated illuminated spacer or bezel 118 is a separate component from the cup holder 116 so that the illuminated spacer 118 can be utilized to illuminate any suitable commercially available cup holder 114 that is available either off-the shelf or as original equipment from a boat OEM. It is noted that the article holder 114 can alternatively be any other suitable type of article holder such as, for example, a fishing rod holder and the like.

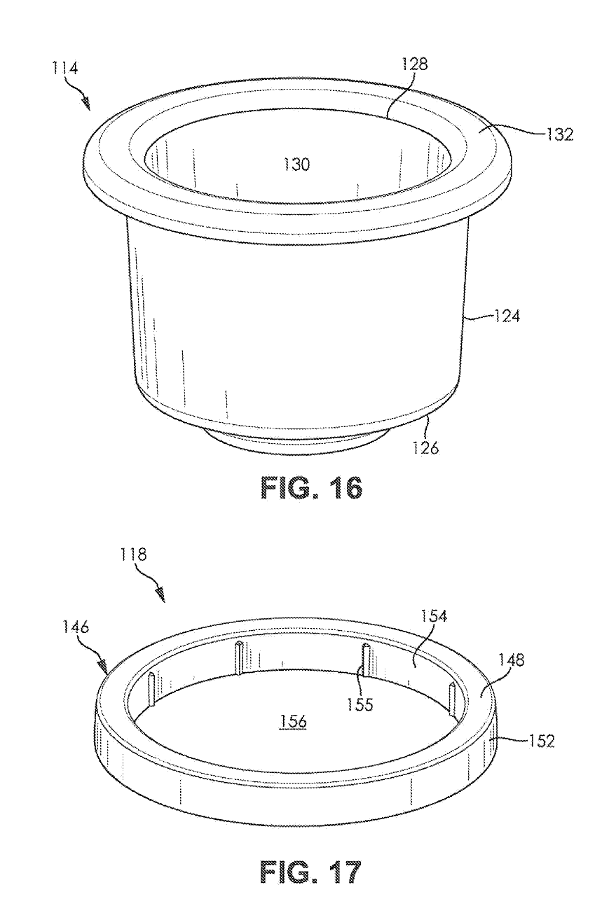

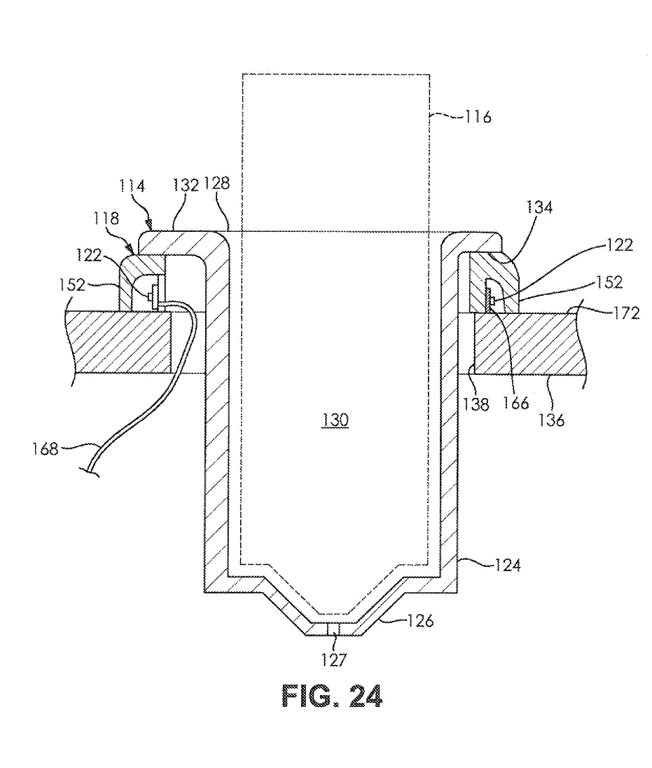

As best shown in FIG. 16, the illustrated cup holder 114 is a flush-type cup holder that includes a cylindrically shaped body 124 having a substantially closed lower end 126 and an open upper end 128 forming an interior cavity 130 and an upper flange 132 extending radially outward from the top of the body 124. The body 124 and its interior cavity 130 are sized for receiving and holding the cup or bottle 116. The illustrated upper flange 132 has a lower surface 134 for supporting the cup holder 114 on the illuminated spacer 118 (but typically is supported on the boat wall 136 when a spacer 118 is not present) with the body 124 extending through an opening 138 in the wall 136 (best shown in FIG. 24). The illustrated upper flange 132 has a circumference sized larger than a diameter of the wall opening 138 so that the flange 132 will not pass through the wall opening 138. The illustrated body 124 has diameter sized smaller than the diameter of the wall opening 138 so that the body 124 can be inserted through the wall opening 138. The illustrated cup holder 114 is formed of stainless steel but the cup holder 114 can alternatively be formed of any other suitable material such as, for example, plastic, other metals, and other suitable materials. It is noted that the body 124 is provided with a suitable drain opening 127 in the closed lower end 126 to prevent the accumulation of water or other debris within the body 124.

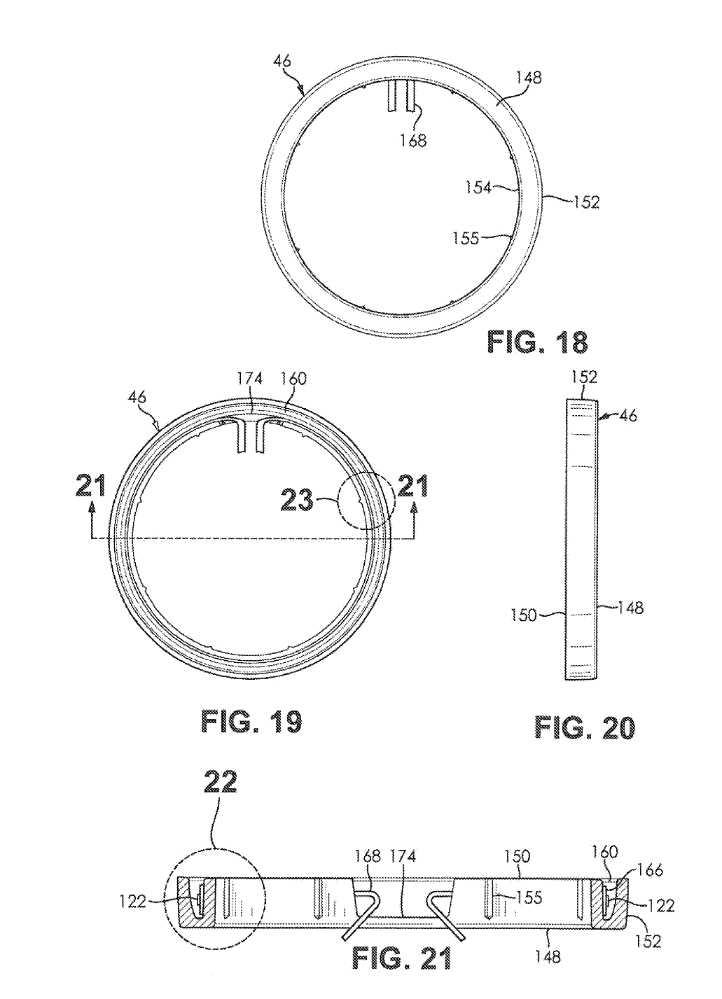

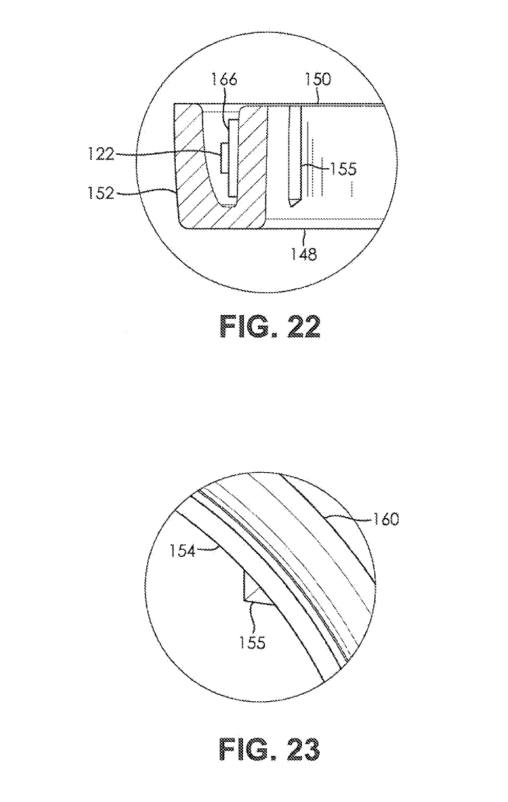

As best shown in FIGS. 17 to 24, the illustrated illuminated spacer or bezel 118 includes the base 146 and the plurality of spaced-apart electric lights 122. The illustrated spacer 118 is configured to be retained between the upper flange 132 of the cup holder 114 and the boat wall 136. The illustrated base 146 is generally ring-shaped having a substantially planar or flat upper surface 148, a substantially planar or flat lower surface 150 opposite the upper surface 146, a peripheral outer surface 152 connecting the upper and lower surfaces 148, 150, and an inner surface 154 connecting the upper and lower surfaces 148, 150 and forming a central opening 156 extending from the upper surface 148 to the lower surface 152. The illustrated upper surface 148 is sized larger than the wall opening 138 and substantially the same or slightly larger than the upper flange 132 of the cup holder 114 so that the lower surface 134 of the body upper flange 132 can engage and be supported on the upper surface 148 of the spacer 118. The illustrated lower surface 150 is also sized larger than the wall opening 138 so that the lower surface 150 can engage and be supported on the boat wall 136 about the wall opening 138. The illustrated peripheral outer wall 152 is circular shaped and extends the full periphery of the base 146. The illustrated outer wall 152 is sized to extend the full height of the gap between the boat wall 136 and the upper flange 132 of the cup holder 114. The illustrated outer surface 152 is arcuate or convex in vertical planes between the upper and low surfaces 148, 150 so that light from the plurality of spaced-apart electric lights 122 is directed in a nonlinear manner (that is, distributed in more than one direction within the vertical planes). It is noted, however, that the outer surface 152 can alternatively have any other suitable shape. The illustrated inner surface 154 is sized to extend the full height of the gap between the boat wall 138 and the upper flange 132 of the cup holder 114 and is substantially vertical. It is noted, however, that the inner surface 154 can alternatively have any other suitable shape. The central opening 156 formed by the inner surface 154 is sized and shaped for passage of the body 124 of the cup holder 114 therethrough with clearance (best shown in FIG. 24). The illustrated inner surface 154 is provided with a plurality of inwardly extending and circumferentially spaced-apart protrusions 155 that ensure a gap or clearance space between the inner surface 154 of the spacer 118 and the cup holder body 124. The illustrated protrusions 155 are triangular-shaped in horizontal cross section and extend the full height of the inner surface 154. It is noted that the protrusions 155 can alternatively have any other suitable shape and/or configuration.

A downward facing groove or track 160 extends about substantially the entire circumference of the base 146 and substantially encircling the central opening 156. The illustrated groove 160 is located between the outer and inner surfaces 148, 150 and is located near the peripheral outer surface 150. The groove 160 is sized for receiving and holding the plurality of spaced-apart electric lights 122 therein to illuminate the outer peripheral outer surface 152 (best shown in FIG. 24). The illustrated groove 160 has a substantially vertical inner surface 162 and an arcuate or concave outer surface 164 that corresponds to the shape of the peripheral outer surface 152 of the base 146. The illustrated groove 160 is open at the lower surface 150 for insertion of the electric lights 122 and access to the electric lights 122. It is noted, however, that the groove 160 can alternatively have any other suitable configuration.

The illustrated base 146 is advantageously molded of a suitable plastic in a one-piece construction but can alternatively be formed of multiple components secured together. At least a portion of the illuminated base 146 is formed of a material suitable for transmitting visible light from the electric lights 122 to at least the peripheral outer surface 152. The material is preferably translucent but can be transparent or otherwise visible light transmissive. The illustrated illuminated base 146 is molded of a single translucent plastic material but any other suitable material or combination of materials can alternatively be utilized.

The plurality of spaced-apart electric lights 122 are provided in the groove 160 of the base 146 to illuminate at least the peripheral outer surface 152 of the base 146. The illustrated electric lights 122 are provided in the form of a flexible strip of LED lights 166 having a plurality of spaced-apart LED lights 122. The illustrated strip of LED lights 166 is water proof in that the strip of LED lights 166 is surrounded or encased by a polymeric or plastic material such as, for example, silicone or the like. Thus, the strip of LED lights 166 is sealed against the entry of moisture and only the electric wires 68 extend therethrough. It is noted that the electric lights 122 can alternatively be any other suitable type of LED lights or any other suitable type of electric lights. The electric wires 168 extend from the strip if LED lights 166 for connection to the boat illumination or lighting system 70. The electric wires 168 can be provided with electrical connectors for easy connection to the boat lighting system 70.

The illustrated strip of LED lights 166 is positioned in the groove 160 against the inner surface 162 of the groove 160 with the LED lights 122 facing outward toward the outer surface of the groove 164 and the peripheral outer surface 152 of the base 146. The illustrated strip of LED lights 166 has a length that extends substantially the entire distance of the groove 160 so that it substantially encircles the central opening 156 of the base 146. The strip of LED lights 166 can be secured to the base 146 within the groove 160 in any suitable manner such as, for example, adhesive, adhesive, tape, and the like.

As best shown in FIG. 24, the illuminated base 146 is positioned between the boat wall 136 and the upper flange 132 of the cup holder 114 such that the lower surface 150 of the illuminated base 146 directly rests on the upper surface 172 of the boat wall 136 and the lower surface 134 of the upper flange 132 rests directly on the upper surface 148 of the illuminated base 146. The body 124 of the cup holder 114 extends downwardly from the flange 132 and through the central opening 156 in the illuminated base 146 and through the opening 138 in the boat wall 136. The plurality of electric lights 122 is located in the groove 160 of the illuminated base 146 and the electric wires 168 extend from the groove 160 to the central opening 156 through a wire passage 174 extending between the groove 160 and the central opening 156. The electric wires 168 then extend down through the opening 138 in the boat wall 136 to the boat illumination or lighting system 70. When power is selectively supplied to the plurality of electric lights 122, they illuminate the peripheral outer surface 152 of the base 146. Thus, the circumference of the upper end 128 of the cup holder 114 is illuminated and can be easily seen at night.

From the foregoing disclosure it is apparent that the illustrated article holder assemblies 12, 112 allow the article holders 14, 114 to be illuminated for easy visibility during evening hours. The LED lights 22, 122 also provide a low power alternative to other accent lighting. Additionally, the illustrated illuminated spacers or bezels 18, 118 allow different article holders 14, 114 from different manufacturers to pair up utilizing a wide variety of combinations. Because the strips of LED lights 66, 166 are waterproof, the LED lights 22, 122 remain operational in all weather conditions. Furthermore, the assemblies 12, 112 can be easily installed with no drilling required to existing rod holder 14 or cup holder 114 locations.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An illuminated spacer comprising, in combination:
a base having a substantially planar upper surface, a substantially planar lower surface opposite the upper surface, a peripheral outer surface connecting the upper and lower surfaces, and an inner surface connecting the upper and lower surfaces and forming a central opening extending from the upper surface to the lower surface;
wherein the base has a circumferentially extending groove encircling the central opening and located between the inner surface and the outer surface;
a plurality of spaced-apart electric lights located within the groove; and
wherein at least a portion of the base is light transmissive so that at least a portion of light produced by the electric lights is transmitted through the outer surface.

2. The illuminated spacer according to claim 1, wherein the electric lights face outward toward the outer surface and wherein at least a portion of the peripheral outer surface is light transmissive so that at least a portion of light produced by the electric lights is transmitted through the outer surface.

3. The illuminated spacer according to claim 2, wherein the peripheral outer surface is convex between the upper and lower surfaces.

4. The illuminated spacer according to claim 1, wherein the plurality of spaced apart electric lights comprise a waterproof and flexible LED light strip located within the groove.

5. The illuminated spacer according to claim 4, wherein the groove faces downward and is open at the lower surface.

6. The illuminated spacer according to claim 1, wherein a passage is formed between the groove and the central opening for passage of electrical wires from the electric lights to the central opening.

7. The illuminated spacer according to claim 1, wherein a plurality of circumferentially spaced-apart fastener clearance openings vertically extend between the upper and lower surfaces.

8. The illuminated spacer according to claim 1, wherein the base is configured to support a fishing rod holder.

9. The illuminated spacer according to claim 1, wherein the base is configured to support a cup holder.

10. An article holder assembly comprising, in combination:
an article holder including a cylindrically shaped body having a substantially closed lower end, an open upper end, and an upper flange radially extending outward about a circumference of the upper end of the body;
an illuminated spacer including a base having a substantially planar upper surface, a substantially planar lower surface opposite the upper surface, a peripheral outer surface connecting the upper and lower surfaces, and an inner surface connecting the upper and lower surfaces and forming a central opening extending from the upper surface to the lower surface;
wherein the base has a circumferentially extending groove encircling the central opening and located between the inner surface and the outer surface;
wherein the illuminated spacer further includes a plurality of spaced-apart electric lights located within the groove;
wherein at least a portion of the base is light transmissive so that at least a portion of light produced by the electric lights is transmitted through the outer surface; and
wherein a lower surface of the upper flange of the article holder engages and is supported on the upper surface of the base and the body of the article holder extends through the central opening of the base.

11. The article holder assembly according to claim 10, wherein the electric lights face outward toward the outer surface and wherein at least a portion of the peripheral outer surface is light transmissive so that at least a portion of light produced by the electric lights is transmitted through the outer surface.

12. The article holder assembly according to claim 11, wherein the peripheral outer surface is convex between the upper and lower surfaces.

13. The article holder assembly according to claim 1, wherein the plurality of spaced apart electric lights comprise a waterproof and flexible LED light strip located within the groove.

14. The article holder assembly according to claim 13, wherein the groove faces downward and is open at the lower surface.

15. The article holder assembly according to claim 10, wherein a passage is formed between the groove and the central opening for passage of electrical wires from the electric lights to the central opening.

16. The article holder assembly according to claim 10, wherein the article holder is a fishing rod holder.

17. The article holder assembly according to claim 10, wherein the article holder is a cup holder.

18. A boat comprising, in combination:
a wall having an opening; and
an article holder assembly comprising:
an article holder including a cylindrically shaped body having a substantially closed lower end, an open upper end, and an upper flange radially extending outward about the circumference of the upper end of the body;
an illuminated spacer including a base having a substantially planar upper surface, a substantially planar lower surface opposite the upper surface, a peripheral outer surface connecting the upper and lower surfaces, and an inner surface connecting the upper and lower surfaces and forming a central opening extending from the upper surface to the lower surface;
wherein the base has a circumferentially extending groove encircling the central opening and located between the inner surface and the outer surface;
wherein the illuminated spacer further includes a waterproof and flexible light strip having a plurality of flexible LED lights located within the groove and extending substantially around the entire central opening; and
wherein at least a portion of the base is light transmissive so that at least a portion of light produced by the LED lights is transmitted through the outer peripheral surface; and
wherein the lower surface of the base of the illuminated spacer engages and is supported on the wall with the central opening of the base of the illuminated spacer located at the opening in the wall, a lower surface of the upper flange of the article holder engages and is supported on the upper surface of base of the illuminated spacer, and the body of the article holder is extending through the central opening of the base of the illuminated spacer and the opening of the wall.

19. The boat according to claim 18, wherein the article holder is a fishing rod holder.

20. The boat according to claim 18, wherein the article holder is a cup holder.
